(19) United States
(12) Patent Application Publication
(10) Pub. No.: US 2016/0300244 A1
(43) Pub. Date: Oct. 13, 2016

(54) Method And System For Authenticating A Packaged Product From A Remote Location

(71) Applicant: Matteo MARCHESANO, Saint Marcel (IT)

(72) Inventor: Matteo MARCHESANO, Saint Marcel (IT)

(21) Appl. No.: 15/036,504

(22) PCT Filed: Nov. 15, 2013
(86) PCT No.: PCT/IT2013/000320

§ 371 Date: May 13, 2016

(51) Int. Cl. G06Q 30/00; G06Q 30/06; H04L 9/06

(52) U.S. Cl. CPC G06Q 30/0185; H04L 9/0643; G06Q 30/0609; G06Q 2220/00

(57) ABSTRACT

The present disclosure aims at providing a method and a system for authenticating a packaged product arranged within a container from a remote location. The characteristic of the method is to comprise the steps of generating (25), for each packaged product, a unique authentication element (8, 15, 19, 23) through an algorithm; providing (26) a plurality of sealings (6, 10, 16, 20), each of which being configured for permanently memorising a respective unique authentication element (8, 15, 19, 23); associating (27)—irreversibly for each product of said plurality of products—the respective sealing to said container containing said product; memorising (28) in a database said association between the product and the respective sealing (6, 10, 16, 20); acquiring (30) said unique authentication element from a remote location, once said packaged product is freely utilisable and/or placed on the market; comparing (31) said acquired unique authentication element with said association between the product and the respective unique authentication element; transmitting (32) the confirmation of the authenticity of the packaged product to a user in real time, if upon said comparison, said acquired authentication element coincide with said memorised association between the product and the respective generated authentication element.

### FIELD OF THE INVENTION

The present description has the object of providing a method and a system for authenticating a packaged product from a remote location, according to claims 1 and 11.

In particular, the present description refers to a method and a system for providing the possibility to a user of authenticating, from a remote location, through a mobile terminal, a packaged product intended for free utilisation and/or and or placing in the market.

### BACKGROUND OF THE INVENTION

It is known that firms, companies, individuals, consortiums, etc. spend considerable amounts of money for advertisement and other marketing initiatives with the aim of creating trademarks and reputation for a product. In some cases, further sums are often spent in developing products to be marketed with these trademarks.

Successful trademarks represent a precious asset for firms, companies, individuals, consortiums, and they are often at the centre of great efforts to supervise the correct and lawful use of such trademarks.

Although these efforts, successful trademarks are unfairly exploited by unethical subjects such as manufacturers and sellers of counterfeit and/or stolen products.

An often even more serious result is the damage to the good name and reputation of the owner of the trademark, especially when a counterfeit product is sold as an authentic product.

With the effort of fighting this problem, the owners fight the counterfeiters by introducing programmes/devices aimed at eliminating or at least reducing such unlawful activities.

While some programmes/devices have been quite successful for a short period of time, the unlawful earnings for the wrongdoers are often so high that the programmes/devices are overcome or even copied.

For example, according to the method currently in use, the container in which the product intended to be used and/or or sold is housed or, more generally, the product packaging, is provided with a recognition identification in form of a code, for example a barcode or a hologram, whose reading allows the identification of the product, the name of the manufacturer as well as any other information regarding the product such as, for example, the expiry date if the product in question is edible.

The recognition indication in form of code, according to the prior art, is usually fixed on the container or on the packaging in such a location to be detected and read by apposite apparatus in that, mainly, such indication is intended to control the movement of the seller warehouse and providing data for preparing sales receipts or invoices.

However, given the visibility thereof on the container or on the packaging, the indication, though in form of a code, may be cloned and deceitfully placed on containers or packagings in which a counterfeit product or the product however not corresponding to the one the original product corresponds to, is arranged.

Therefore, the coded indication, according to the prior art, applied in positions visible on the container or on the packaging of the product are not capable of guaranteeing, through the reading thereof, the actual authenticity of the purchased product, in other words, the matching between the product and the name and the origin declared on the container or on the packaging of the product.

### SUMMARY OF THE INVENTION

The object of the invention in question is to provide a method and a system capable of overcoming the problems observed in the prior art.

An embodiment allows obtaining a method and a system which, contrary to the known methods and systems of authentication, allows obtaining easy use, inexpensive accessibility both for the user (or consumer/purchaser of the packaged product) and for the manufacturer/seller of the product.

The present invention allows obtaining a method and a system capable of allowing the user (or consumer/purchaser of the packaged product) to verify the authenticity of the packaged product in real time.

In addition, the method and the system of the invention allows geolocalising the remote location in which the authentication occurs.

Lastly, the method and system of the invention allows guaranteeing resistance to reverse engineering attacks and, especially, compliance with the ISO 12931:2012 standard, which provides indeed for tampering with the integrity of the packaging or part of the product or the like.

### BRIEF DESCRIPTION OF THE FIGURES

The characteristics and advantages of the present disclosure shall be evident from the following detailed description of possible practical embodiments thereof, illustrated by way of non-limiting example in the assembly of drawings, wherein:

FIG. 1 illustrates a flow chart of the method for authenticating the packaged products arranged in a container from a remote location, according to the present invention;

FIG. 2 schematically shows, in perspective view, a box-shaped packaging with sealing on the opening, according to the invention, in closed position and with authentication element of the product arranged on the rear surface of the sealing;

FIG. 3 shows the packaging of FIG. 2 in open position with sealing broken;

FIG. 4 shows, in perspective view, the end of the neck of a bottle with cover capsule serving as a sealing, in closed position, with authentication element arranged on the inner surface of the capsule facing towards the visible end of the cap, according to the present invention;

FIG. 5 shows, in perspective view, the end of the neck of the bottle of FIG. 4 with capsule open at the cap for closing the bottle;

FIG. 6 shows, in perspective view, the end of the neck of a bottle with closure cap serving as a sealing, in closed position, provided with tear means for the easy opening thereof with authentication element arranged on the rear of the tubular part of the capsule, according to the present invention;

FIG. 7 shows, in perspective view, the end of the neck of a bottle like in FIG. 6 with a cover capsule serving as a sealing, in open position;

FIG. 8 shows, in perspective view, the end of the neck of a bottle with a cover capsule serving as sealing, in closed position provided with tear means for the easy opening thereof with authentication element arranged on the rear of the opening tab of the capsule, according to the present invention;

FIG. 9 shows, in perspective view, the operation of breaking the capsule of FIG. 8 with the display of the authentication element;

FIG. 10 shows, in perspective view, the operation of reading the authentication element shown in FIG. 9 through a mobile terminal, according to the present invention;

FIG. 11 shows a further perspective view of the end of the neck of a bottle with cover capsule serving as sealing, in closed position provided with tear means for the easy opening thereof with authentication element arranged on the rear of the opening tab of the capsule, according to the present invention.

### DETAILED DESCRIPTION

Even though not explicitly shown, the single characteristics described with reference to the specific embodiments shall be described as accessory and/or interchangeable with other characteristics, described with reference to other embodiment examples.

Within the scope of the present invention, the term container is used to indicate a general box in which there is placed a product freely utilisable and/or placed in the market intended for use or consumption by a purchaser, same case applying, for example, to a bottle containing wine or liquor or any other type of liquid product, whether edible or not.

It should be immediately observed that the products are obtained i.e. provided directly by a producer/seller of the products.

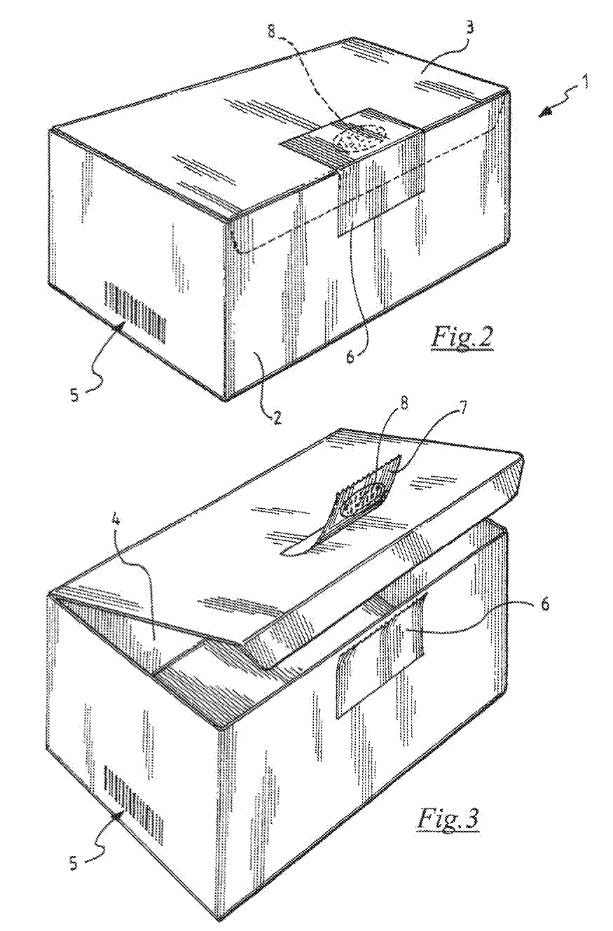

With reference to FIGS. 2 and 3, a general and conventional box-shaped packaging having a portion 2 which has the function of a container and a portion 3 having the function of a cover for closing and opening the opening 4 which determines the access into the container for the introduction and removal of the product, not illustrated, contained in the packaging is indicated with 1.

In a wall of the packaging, in a position observable from the external, there may be placed a conventional barcode, or a hologram, schematically indicated with 5, to be read through the conventional product identification operations, for example when selling and issuing a receipt.

The packaging is also provided with a sealing 6, fixed using conventional methods between the cover 3 and the container 2, with the function of maintaining the opening 4 closed and guaranteeing the integrity of the packaging.

According to the invention, the sealing 6 is provided, in a portion of the surface 7 thereof faced towards the packaging and thus neither accessible nor observable from the external when the sealing is integral and applied on the packaging, of an authentication element 8 of the product.

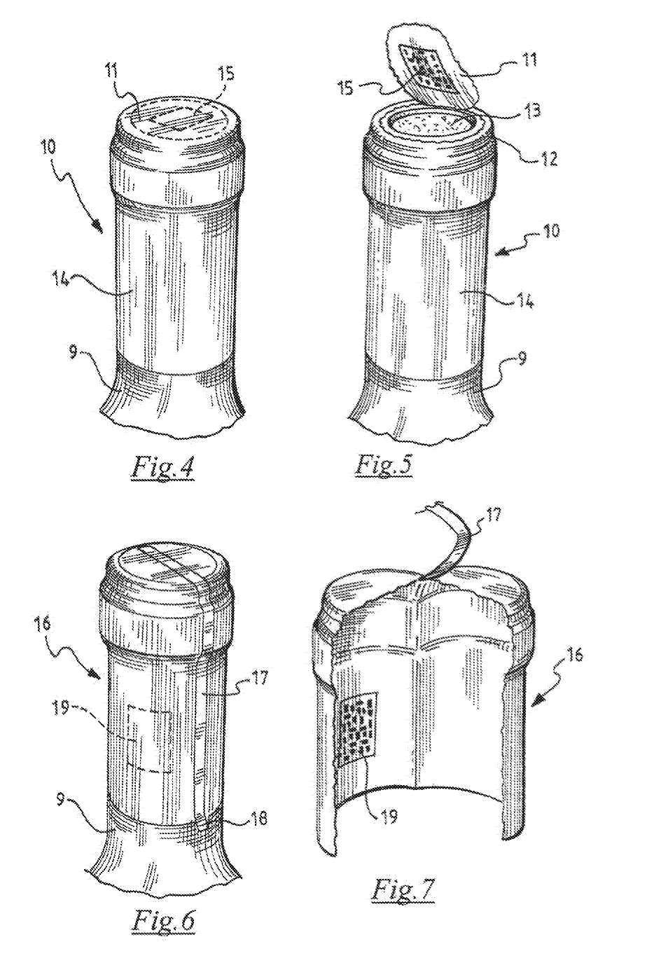

With reference to FIGS. 4 and 5 it is observed that, in case of bottles 2 A, particularly those intended to contain prestigious beverages, in a first embodiment, the neck 9 is covered by a capsule 10 which serves as a sealing.

The latter comprises a portion 11 which extends above the end 12 of the neck, closed by a conventional cap 13, and at least one tubular portion 14 which extends axially around the neck.

As known, the cover capsule 10, in a conventional embodiment thereof, may be made of plastic PVC material, or polylaminate, or even aluminium or tin or PET. After being placed on the neck 9 of the bottle it is made to adhere thereto thus covering the cap and serving the sealing functions.

According to the invention and as illustrated in FIGS. 4 and 5, the capsule 10 in an embodiment thereof, is provided with an authentication element 15, positioned in the portion 11 on the surface thereof facing towards the cap 13.

In particular, upon opening the bottle, before extracting the cap 13, at least partly, from the tubular portion 14 of the capsule allows accessibility and visibility of the authentication element 15 which can thus be read.

With reference to FIGS. 6 and 7 it is observed that, in a different embodiment, the capsule, indicated with 16, is provided with an axial area 17 with easy breaking in form of a tab with an end 18 so as to allow easy grabbing for tearing and removing the capsule 16.

In particular, the axial area 17 extends along the axis of the neck 9 of the bottle 2A continuing along a diameter of the cap 13.

As shown in FIG. 7, in the inner tubular surface 16a, not visible from outside when the capsule 16 is arranged on the neck 9 of the bottle, there is arranged the authentication element indicated with 19 which may thus be read only after breaking the capsule 16 which constitutes the sealing of the bottle.

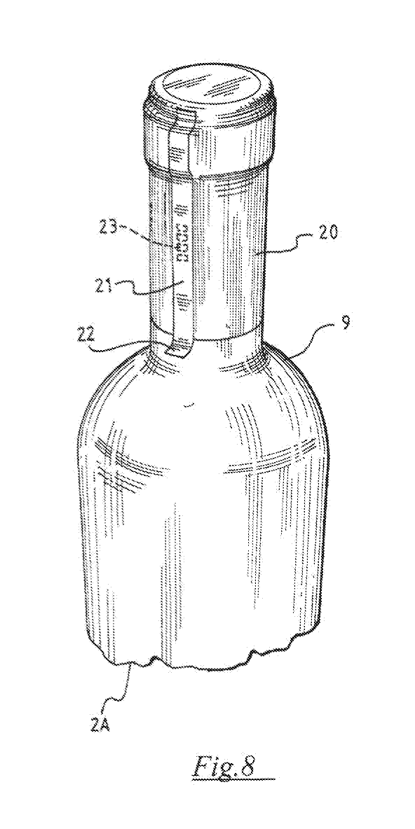

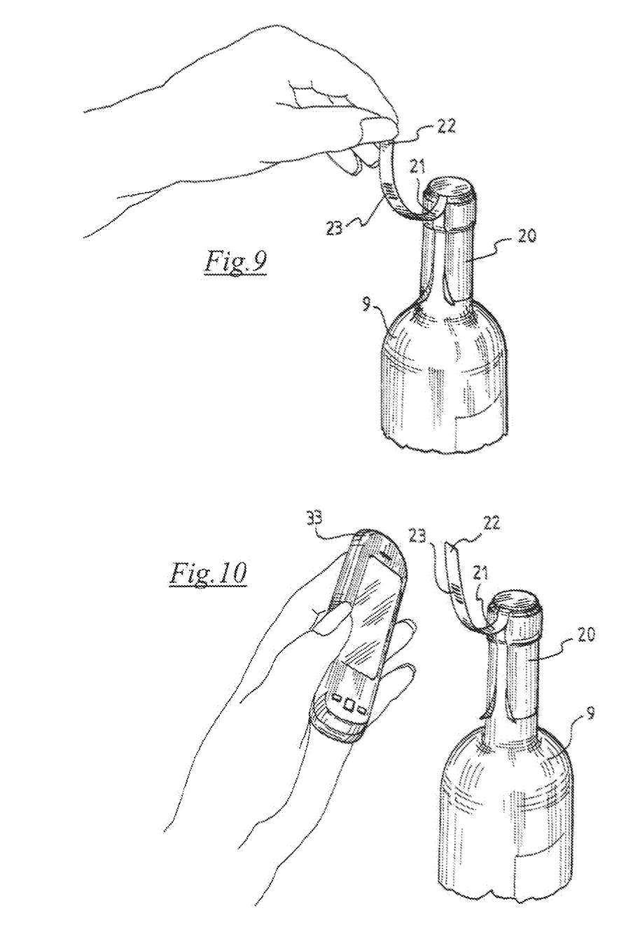

A different embodiment of the capsule according to the invention is shown with reference to FIGS. 8 and 9.

The capsule 20, arranged on the neck 9 of a bottle, is provided with an area 21 with easy opening in forma of a tab with an end 22 for manually grasping for tearing.

According to the invention, the inner surface of the tab 22 is provided with an authentication element 23 not shown from outside.

In particular, the area 21 with easy opening extends along the axis of the neck 9 of the bottle 2A, i.e. parallel to the axis of the neck of the bottle.

A different embodiment of the capsule according to the invention is shown with reference to FIG. 11.

Also in this case the capsule 20, arranged on the neck 9 of a bottle, is provided with an area 21 with easy opening in form of a tab with an end 22 for manually grasping for tearing.

According to the invention, the inner surface of the tab 22 or the portion 11 on the surface thereof facing towards the cap 13 is provided with an authentication element 23 not visible from the external.

In particular, the area 21 with easy opening extends circumferentially to the neck 9 of the bottle 2A.

It should be observed that in a further embodiment the unique authentication element 8, 15, 19, 23 may be arranged both on the tab and in the area of the capsule simultaneously so as to guarantee the reading should one of the authentication elements be damaged or not readable.

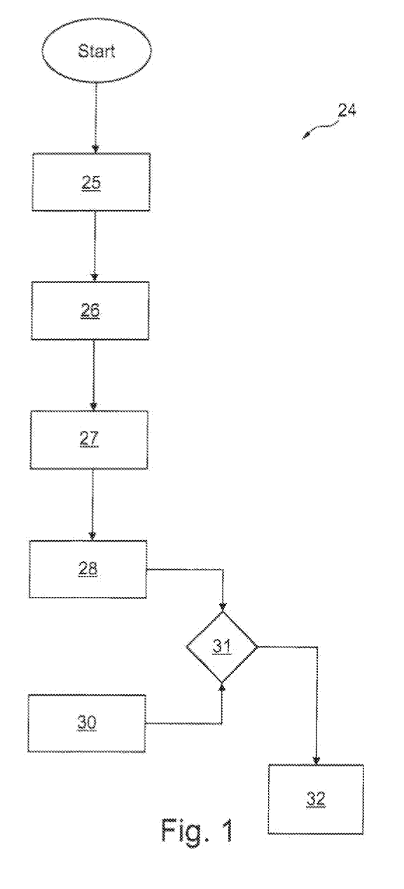

With the aim of providing the possibility of authenticating the product contained in the packaging and, with reference to the flow chart illustrated in FIG. 1, there is advantageously provided a method 24 for authenticating the packaged products arranged in the container 2, 2A.

In particular the method 24 allows the authentication of the product contained in the container 2, 2A by a user from a remote location.

The method 24 comprises the step, block 25, of generating for each packaged product in the container 2, 2A the unique authentication element 8, 15, 19, 23 through an algorithm.

Preferably the algorithm is configured for generating unique authentication elements, starting from always different alphanumerical data threads, such as for example the product identification code normally used for example by the producer/seller.

Such unique authentication elements 8, 15, 19, 23 may also be cryptographed, through cryptographic protocols of the sha-1, sha-2, md5 type or the like. This guarantees that the authentication element 8, 15, 19, 23 is unique in a statistically certain manner and protected against reverse engineering attacks.

It should be observed that the step of generating, block 25, for each product the unique authentication element 8, 15, 19, 23 through the algorithm, for example of the cryptographic type, is performed by a certifying body, such certifying body being different from the producer/seller of the product.

The method comprises the step, block 26, of providing a plurality of sealings 6, 10, 16 and 20 each of which being configured for permanently memorising a respective unique authentication element 8, 15, 19, 23.

For example the step of permanently memorising the unique authentication element 8, 15, 19, 23 consists in transferring such authentication elements 8, 15, 19, 23 on the sealings 6, 10, 16 and 20 through for example a printing operation, if the sealing is provided in a paper medium or a capsule for bottles, or memorise them in a memory portion of an RFID chip.

The method 24 comprises the step, block 27, of associating—irreversibly for each product—the respective sealing 6, 10, 16 and 20 to the container 2, 2A containing the product.

The sealing 6, 10, 16 and 20 on which there is transferred the unique authentication element 8, 15, 19, 23 is thus associated to the container containing the products.

The method through which the association of the sealing 6, 10, 16 and 20 to the container 2, 2A is performed is known to a man skilled in the art and thus it shall not be described.

The method 24 provides the step, block 28, of memorising such association between the product and the respective sealing 6, 10, 16 and 20. In particular it is provided for memorising, in a suitable database, such specific association for each product that the producer/seller may wish to subject to the method of the present description. It should be observed that the memorisation step, block 26, same case applying to the comparison step, block 31, are performed by the certifying body. This guarantees that the unique authentication element 8, 15, 19, 23 is known to the certifying body alone and not to the producer/seller so that the unique authentication element 8, 15, 19, 23 is actually secret for everyone except for who actually generated it.

Once the packaging containing the products are freely utilisable and/or placed in the market, the method comprises the step, block 30, of acquiring the unique authentication element 8, 15, 19, 23 from a remote location.

Such remote location represents the physical place in which there occurs the utilisation and/or placing of the packaged product in market.

For such purpose the authentication element 8 may be read only when it is made accessible following the breaking of the sealing 6 and, as indicated in FIGS. 3, 5 and 7, after lifting the portion of sealing that includes it.

In particular, the process of association of the sealing 6, 10, 16 and 20 to the container 2, 2 A has the paramount aim of jeopardising the integrity of the container or a part of the product or the like so as to be able to verify the authenticity thereof, in compliance with the ISO 12931:2012 standard.

The method 24 comprises the step, block 31, of comparing the unique authentication element 8, 15, 19, 23 acquired with the association between the product and the respective unique authentication element memorised in the database and the confirmation of the authenticity of the packaged product is transmitted to the in real time user, block 32, should, following such comparison, the acquired authentication element coincide with the memorised association between the product and the respective generated authentication element.

On the contrary, should it not coincide—following the comparison, block 31, between the unique authentication element 8, 15, 19, 23 acquired with the association between the product and the respective unique authentication element memorised in the database—then the confirmation of the non-authenticity of the packaged product is transmitted to the user in real time, block 32.

The user may also be informed, block 32, should the acquired unique authentication element 8, 15, 19, 23 reveal to have been read previously following the comparison, block 31. This represents a further guarantee of authenticity of the product given that two unique authentication elements 8, 15, 19, 23 cannot be associated to the same product.

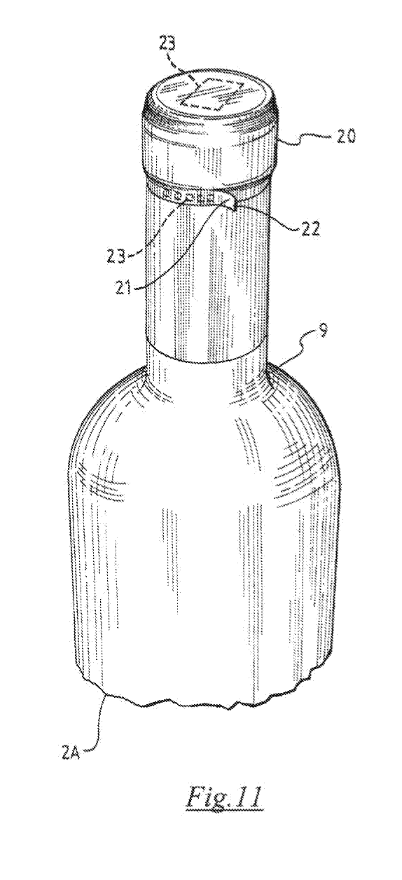

With the aim of performing the step of acquiring, block 30, comparing, block 31 and transmitting to the user the result of the comparison, block 32, it is provided for using, for example as illustrated in FIG. 10, a mobile terminal 33 provided with a computer programme so as to allow reading the authentication element 8, 15, 19, 23 and sending the latter to a remote server.

In particular the mobile terminal 33, once the packaged product is freely utilisable and/or placed on the market, is configured for:
acquiring the unique authentication element 8, 15, 19, 23 in such remote location in which the utilisation and/or placing on the market occurs;
sending the acquired unique authentication element 8, 15, 19, 23 to the remote server,
receiving from the remote server the result of the comparison between the unique authentication element memorised in the database and the acquired unique authentication element 8, 15, 19, 23;
informing the user, through a graphic interface observable on a screen of said mobile terminal 33, about the result of said comparison.

In other words, the computer programme present in the memory of the mobile terminal 33, through the remote server, verifies whether the unique authentication element 8, 15, 19, 23 was actually generated by the certifying body.

Should this occur, the remote server shall verify whether the unique authentication element 8, 15, 19, 23 in question was previously received by another user, with possibility of returning details if affirmative or response of official authenticity in case of negative result.

Furthermore, it should be observed that the mobile terminal 33 acquires the geographic coordinates of the remote location sending them to said remote server.

Such geographic coordinates are used for example for tracking the product sales and purchase position.

The transmission of the unique authentication element 8, 15, 19, 23 and/or of the geographic coordinates of the remote location to the remote server same case applying to sending the comparison result, block 31, to the mobile terminal 33 are carried out through, for example, a telephone network of the mobile or landline type.

It should be observed that the remote server is maintained by the certifying body, wherein the remote server comprises the database in which the association between the product and the respective sealing is memorised.

According to a preferred embodiment the mobile terminal 33 is selected from the group comprising smartphones, tablets, notebooks, netbooks, personal computers and the like.

Obviously, the embodiments of the method and the system for authenticating the packaged products arranged in a container from a remote location described previously may be subjected to modifications by a man skilled in the art, with the aim of meeting contingent and specific needs, all falling within the scope of protection as described by the claims that follow.

I claim:

1. Method for authenticating a packaged product arranged within a container (2, 2 A) from a remote location, said method comprising the steps of:
generating (25) for each packaged product a unique authentication element (8, 15, 19, 23) through an algorithm;
providing (26) a plurality of sealings (6, 10, 16, 20), each of which being configured for permanently memorising a respective unique authentication element (8, 15, 19, 23);
associating (27)—irreversibly for each product of said plurality of products—the respective sealing to said container containing said product;
memorising (28)—in a database—said association between the product and the respective sealing (6, 10, 16, 20);
acquiring (30) said unique authentication element from a remote location, once said packaged product is freely useable and/or placed on the market;
comparing (31) said unique acquired authentication element through said association between the product and the respective unique authentication element;
transmitting (32) the confirmation of the authenticity of the packaged product to a user, in real time should, should—following said comparison—said acquired authentication element coincide with said memorised association between the product and the respective generated authentication element.

2. Method for authenticating a packaged product arranged within a container from a remote location according to claim 1, wherein said algorithm for generating said unique authentication element comprises a cryptographic algorithm.

3. Method for authenticating a packaged product arranged within a container from a remote location according to claim 1, wherein said unique authentication element memorised in said sealing is not visible to said user, when said packaged product is utilisable and/or placed on the market.

4. Method for authenticating a packaged product arranged within a container from a remote location according to claim 1 or 3, wherein said sealing (6, 10, 16, 20) comprises a support on which said unique authentication element is printed.

5. Method for authenticating a packaged product arranged within a container from a remote location according to any one of the preceding claims, wherein the step of acquiring (30) said unique code comprises a step of breaking said sealing (6, 10, 16, 20), the latter being breakable to allow the opening of the container (2, 2A) and access the product contained in said container.

6. Method for authenticating a packaged product arranged within a container from a remote location according to claim 1 or 3, wherein said sealing (6, 10, 16, 20) comprises an electronic device of the RFID type in which said unique authentication element (8, 15, 19, 23) is memorised.

7. Method for authenticating a packaged product arranged within a container from a remote location according to claim 1, wherein said product is provided by a producer/seller of the product.

8. Method for authenticating a packaged product arranged within a container from a remote location according to claim 1, comprising the step of acquiring geographic coordinates of said remote location.

9. Method for authenticating a packaged product arranged within a container from a remote location according to any one of the preceding claims, wherein said step of generating—for each product of said plurality of products—a unique authentication element through an algorithm is performed by a certifying body, said certifying body being different from said producer.

10. Method for authenticating a packaged product arranged within a container from a remote location according to claims 1 and 8, wherein said step of memorising said association between the product and the respective unique authentication element, said step of comparing said unique acquired authentication element through said association between the product and the respective unique authentication element and said step of acquiring said geographic coordinates of said remote location is performed by a certifying body, different from said producer.

11. System for authenticating a packaged product arranged within a container from a remote location, said system characterised in that it comprises:
a device for recognising the authenticity of a packaged product, arranged within a container provided with a passage through which the product may be extracted for utilisation or consumption thereof, comprising a sealing (6, 10, 16, 20) whose breakage is executed for allowing the opening of the said passage;
a unique authentication element (8, 15, 19, 23) of the product positioned on a portion of the sealing (6, 10, 16, 20) not visible from the external and accessible solely following the breakage of the sealing, said authentication element being generated through an algorithm, said authentication element being unique for the respective packaged product;
a mobile terminal (33) provided with a computer programme which, once said packaged product is utilisable and/or placed on the market, is configured for:—acquiring said unique authentication element in said remote location;
sending said unique authentication element to a remote server,
receiving from said certifying body the result of the comparison between said unique authentication element and said unique acquired authentication element;
informing a user, through a graphic interface which can be displayed on a screen of said mobile terminal, about the result of said comparison.

12. System for authenticating the packaged products arranged in a container from a remote location according to claim 11, wherein said mobile terminal (33) acquires the geographic coordinates of said remote location sending them to said remote server.

13. System for authenticating the packaged products arranged within a container from a remote location according to claim 11, wherein said mobile terminal (33) is selected from the group comprising smartphones, tablets, notebooks, netbooks, personal computers and the like.

14. System for authenticating the packaged products arranged within a container from a remote location according to claim 11, wherein said remote server is maintained by said certifying body, said remote server comprising said database in which said association between said product and the respective sealing is memorised.

15. System for authenticating the packaged products arranged within a container from a remote location according to claim 11, wherein said algorithm is cryptographic algorithm.
